(19) United States
(12) Patent Application Publication
(10) Pub. No.: US 2015/0342129 A1
(43) Pub. Date: Dec. 3, 2015

(54) PLANT POT ASSEMBLY

(71) Applicant: MAXIPOT LIMITED, Manchester (GB)

(72) Inventor: Michael BOYLAN, Manchester (GB)

(21) Appl. No.: 14/759,289

(22) PCT Filed: Jan. 3, 2014
(86) PCT No.: PCT/GB2014/000005

§ 371 Date: Jul. 6, 2015

(30) Foreign Application Priority Data
Jan. 5, 2013 (GB) 1300180.5

(51) Int. Cl. A01G 9/02; A01G 1/00

(52) U.S. Cl. CPC A01G 9/02; A01G 1/001

(57) ABSTRACT

The present invention relates to a plant pot apparatus comprising a tray having a base and a raised rim. The apparatus further comprises a pot comprising a sidewall and a base defining an internal cavity. The pot provides at least one recess. The apparatus further comprises a support means arranged in use to stand on the tray and support the pot. At least a portion of the support means is arranged in use to be received within the at least one recess of the support means. The support means is adjustable so as Ito be arranged in use to support said pot in a first position in which the pot base is in contact with the tray and in a second position in which said base is supported spaced apart from the tray. The support means and/or pot is arranged in use to be rota table from the first position to the second position.

### RELATED APPLICATIONS AND CLAIM OF PRIORITY

This patent document claims priority to International Patent Application No. PCT/GB2014/000005, filed Jan. 3, 2014, which in turn claims priority to United Kingdom Patent Application No. 1300180, filed Jan. 5, 2013. The disclosure of each priority application is hereby incorporated by reference.

### BACKGROUND

The present invention relates to plant pot assemblies, especially plant growing and hydroponic equipment having adjustable exposure to liquid nutrients, and in particular to a plant pot for controlled exposure of plant roots to liquid nutrients.

It is known in the field of hydroponics and of plant growth in containers and pots to control the degree of hydration of the plant roots and the degree and timing of exposure to liquid nutrients. In growing crops for taste such as fruit, it is advantageous to take root out of contact with nutrients as the fruit ripens so as to improve the flavor. Generally plants are lifted out of a nutrient dish, or in more complex arrangements suitable for commercial plant growth, nutrients are pumped out of a plant growth container and then replaced when necessary. However, there are no simple means to control the exposure of a potted plant to liquid nutrients that are adapted for both home and commercial use. A plant growth container, such as a plant pot, providing such capability will have practical and commercial utility.

Accordingly, a number of patent applications have been filed in an attempt to resolve the problem or similar, including the following:

KR20040060691 discloses a flowerpot having a soil cultivation frame for being filled with culture soil at the upper part and a hydroponic cultivation frame for receiving water at specified levels in the lower part is provided. It promotes the healthy growth of plant roots, prevents the death from cold and automatically supplies water.

The flower pot is characterized in that it comprises: a flowerpot body (40) opened at the top, formed with a support leg (41) on the bottom face and a sleeve (42) upwardly formed while being integrally formed with the bottom face on the center bottom face; a hydroponic cultivation frame (50) installed at the inside lower part of the flowerpot body, formed by a through-hole part (51) at the inside center and a water discharge unit (52a) formed on the circumference of the through-hole part to discharge water with above specified water levels; and a soil cultivation frame (60) disposed within the hydroponic cultivation frame to be placed inside the flowerpot body, filled with culture soil.

This device holds the soil above a liquid level in a tray but is not height adjustable to move the pot from being in contact with the liquid to being out of contact.

U.S. Pat. No. 5,860,249 discloses a plant watering container assembly comprising a bottom container section having side and bottom walls defining a water reservoir, and a top container section removably connected to said bottom container section. The top container section includes an integrally formed funnel-shaped section having a side wall extending downwardly toward said reservoir and defining a conical opening for receiving a side wall of a potted plant, and further having an integrally formed annular bottom wall defining at its radially inner edge a central opening through which a watering wick can pass downwardly into the reservoir. In the event the container is tipped or turned, water in the container reservoir is trapped in an annular chamber defined by the wall of the funnel and the top and bottom container sections, thereby precluding water passing outwardly through the central opening of the funnel-shaped section.

This device provides controlled access of liquid to a pot by means of wick—the pot is not height adjustable.

SE8301996 The invention concerns a method of growing plants, especially forest plants, such as spruce and pine, in plates 8 of growth substrate with an air gap between the plates and the dirt, wherein a perforated bottom 6, which by means of legs 16 which can be lifted and lowered in relation to the frame, is held at a distance from the dirt. By lifting and lowering during the growth period, one can lower the containers until the growing plates are located near the ground or touching it during cold weather.

This device discloses an adjustable height positioning system for plants, but to avoid contact with cold ground rather than to allow flushing of the soil.

U.S. Pat. No. 4,211,034 discloses a hydroponic growing system consists of an elongated growing unit disposed above a supply tank which normally contains a nutrient solution. The growing unit contains pearlite or another solid particle growing medium into which the plant roots extend. Periodically nutrient solution is pumped into the growing unit and then air is pumped through the nutrient solution and growing medium in the growing unit to aerate the plant roots which extend into the growing medium. Thereafter, much of the nutrient solution is permitted to drain from the growing unit to the supply tank with some of the solution adhering to the growing medium to nourish the plant roots.

In this device the problem of controlling the liquid and nutrients surrounding a plant is solved by pumping liquid into the plant environment and then out again as needed.

It is clear from the prior art that no prior art exists that addresses the needs outlined above.

### SUMMARY

Accordingly, the present invention relates to a plant pot system for flushing nutrients from soil contained therein, the system comprising: a pot having an outer wall connected to a base, wherein a recess is provided within the base of the pot and the recess has a plurality of support indents extending into the recess with channels therebetween, the channels being substantially perpendicular to the base of the pot and extending towards the top of the recess; and a support means comprising at least one ledge about its circumference and arranged, in use, to support the pot; wherein at least a portion of the support means is received within the recess of the pot in a first position, when in use, and wherein in a second position, the pot is rotationally offset from the first position with respect to the support, less of the support means is accepted within the recess and the at least one support indent of the pot rests upon the at least one ledge of the support means, thereby providing a gap between the base of the pot and the base of the support.

A tray may be used to rest the assembly upon and to provide a larger footprint for the support.

The use of a ledge on the support means and an indent in the recess of the pot allows for a simple and effective support arrangement to raise the position of the pot with respect to a surface upon which the support and pot are positioned. This allows a user to lift the roots of the plant in the pot out of any water. This is particularly useful where a rimmed tray is used, which would retain water and the roots would be left in the retained water. This also allows water to run through the soil and flush out nutrients. As many plants thrive in being in unsaturated soil, the present invention allows a user to water a plant without leaving it stood in water, which would damage the plant. The risk of overwatering is reduced.

The first position may be with the base of the pot sat on the same surface as the support means or it may be slightly raised from the surface, creating a small gap between the base of the pot and the surface. The second position raises the pot vertically on to a higher position on the support means and so raises the base of the pot from the surface upon which it was positioned, or raises it to increase the gap under the base of the pot.

Preferably, the pot may be moved between said first arid second positions by rotation of the pot, and more preferably, the pot is moved between the first and second positions by a user lifting the pot substantially vertically clear of the support and rotating it before setting it down on the support. The use of a ‘lift and twist’ arrangement means that a user does not have to move the pot horizontally. A small vertical lift and a twist of the pot allows it to sit on the supporting means in a raised position. Taking into account that a 20 litre pot is very heavy, this reduces the risk of injury because the movement is only up, rotation and down, rather than having to relocate the pot horizontally.

The upstanding portion or protrusion of the support means may further comprise straight regions of the sidewall between the ledges, within which the support indents on the base of the pot may be shaped and dimensioned to be located, when the pot is in the first position.

Preferably, the one or more ledges provide a raised portion adjacent the straight portions. The raised portion may be arranged in use such that the support feature on the base of the pot may be lifted over said raised portion in order to rotate the pot from the second position back to the first position.

In this way in use the pot may be placed over the support means, the upstanding portion may, in use, be fitted into the recess of the pot to an extent determined by interaction of one or more features on the base. When in the first position, the support features may be arranged to lie adjacent the straight portions of the upstanding portion. The upstanding portion may be arranged, in use, to fit substantially the whole way into the recess such that the pot base rests on the tray. If the pot is then lifted and rotated to the second position the support features are now arranged to be adjacent to the ledges on the upstanding portion, and when the pot is lowered again the support features are arranged in to rest on the ledges, so supporting the pot above the tray. In a preferred embodiment, in which the ledges have a raised portion adjacent the straight portion of the upstanding portion, the raised portion may act, in use, to prevent accidental movement of the support features off from the ledges which would result in the pot falling back down to rest on its base. A lifting action is then needed to lift the support features over the raised portion in order to rotate the pot back to the first position.

In a preferred embodiment, the recess of the pot is substantially circular in cross section. The support means comprise at least one protrusion, which is shaped and dimensioned to be received within the at least one recess of the pot. For example, the support means may comprise at least one substantially circular cross section protrusion (for example an upstanding portion) shaped and dimensioned to be received within the opening of the recess at the base of the pot. The support means, which may be a protrusion or an upstanding portion, has one or more projections such as for example ledges extending outwardly from the circumference of the protrusion/upstanding portion. The one or more projections/ledges may be arranged in use to support the supporting indents within the recess when the pot is arranged in the second position.

In use, the plant pot apparatus of the invention is especially suited for maintenance of fruits or other edible plants indoors, but the invention is not limited to indoor use and is applicable outdoors too. To optimize taste it is necessary to flush out nutrients from the soil without taking the plant out of its growing environment. The plant pot assembly can be used at the end of the growing cycle and also for treating nutrient deficiencies such as ‘nutrient burn’. The plant pot assembly can be used to facilitate the flushing process by a simple ‘lift and twist’ action, taking the roots out of the water and thus allowing the soil to drain, thereby benefiting the user by allowing the plants to take on more nutrients, boosting growth, while allowing a faster flushing time of around one week instead of the usual 2 to 3 weeks using prior art plant pots.

Preferably the ledges comprise a sloping portion adjacent to the straight region of the upstanding portion(s) which act in use to provide a gradually rising support to the pot base in moving from the first to the second position, and a gradually falling support in moving from the second position back to the first. This is more pronounced where a series of steps are provided, thereby allowing various predetermined height adjustments to be made.

In a preferred embodiment, the recess comprises a substantially circular depression in the base of the pot. The recess may further comprise a plurality of support features, such as, for example indents, extending from the periphery of the recess towards the centre of the recess, for example, towards the center of the circular depression.

In this way, when the indents of the recess are aligned with the straight sided portions of the upstanding portion of the support means, they clear the straight sides and the upstanding portion enters into the recess, allowing the pot to rest on the tray, where used. When the indents are aligned with the support ledges that project outside the circumference of the upstanding portion, they do not clear the ledges and rest on them, holding the upstanding portion further out from the recess and so preventing the base from contacting the base. It will be understood that a rotating movement will move the Indents from being aligned with the straight sided regions to being aligned with the ledges, thereby supporting the pot, in use, from the first, lowered position to the second, raised position.

Preferably, a number of ledges and matching support features are provided and are evenly spaced around the circumference of the support, or “upstand”, and the pot recess. In a preferred embodiment three ledges and three matching support features are provided. In further embodiments the number may be two, four or a higher number.

In a preferred embodiment the pot and tray are substantially circular in cross section and may resemble a conventional plant pot and tray. Preferably the pot and the rim of the tray have an outward slope from the base as known in conventional plant pots.

Preferably the pot comprises a number of drain holes in the base.

Preferably the pot comprises a number of aerating gaps open to the side of the pot adjacent to the base.

In a preferred embodiment the tray comprises locating features to locate the support means on the tray. Preferably the tray is in the form of a circular dish and the locating features are coaxial with the tray.

In an alternative embodiment the support means is attached to the tray and may be separable from it. In a further embodiment the support means forms part of the tray and may be formed integrally, for example, as part of the same molding.

In use, a significant obstacle to removal of spent liquid nutrients from a plant pot is removal from the tray in which the pot stands. A means of doing this adapted for easy use with the pot is highly advantageous.

Therefore, the plant pot assembly may further comprise a scoop arranged in use to fit into the space between the sidewall of the pot and the rim of the tray. For example, at least one dimension, for example the height or width, of the scoop is less than the space provided in use between the sidewall of the pot and the rim of the tray.

For example the scoop may comprise: an inner wall, an outer wall, a rear wall each joined to a base to form an open topped container having an open front end, wherein the dimension between the outer side of the inner and outer walls at a height above the base is less than the distance between the sidewall of the pot and the rim of the tray at the said height above the base of the tray.

In this way the scoop may in use fit between the pot and the tray rim and in use may pick up liquid from that space into the scoop via the open end.

In a preferred embodiment, in which the pot and the tray have circular cross sections, the inner and outer walls of the scoop are curved, the inner wall having a radius larger than the external radius of the pot and the outer wall having a radius less than the inner radius of the tray rim.

In embodiments in which the pot and the tray rim have an outward sloping profile the inner and outer walls of the scoop have a slope adapted to clear the sidewall of the pot and the rim of the tray.

In this way the curved scoop of the invention may be moved around the base of the tray between the pot and the rim to remove liquid.

Preferably, the scoop comprises a raised and gripped surface on the external sides of the inner and outer walls to allow easy handling.

The plant pot assembly may have a range of dimensions typical of existing plant pots and trays. According to the embodiment the plant pot may have a minimum internal diameter at the base in the range less than 10 cm, more preferably between 10 cm and 20 cm, more preferably still greater than 20 cm. The height of the plant pot may be up to 10 cm, more preferably in the range 10 cm to 20 cm, more preferably still greater than 20 cm. The tray may have a diameter greater than that of the base of the pot by an amount in the range below 5 cm, more preferably between 5 cm and 20 cm. It will be understood that the larger the pot and tray, the larger the preferable gap between the pot and the rim.

According to a further aspect the invention provides a method of cultivating plants comprising the steps of: Providing a plant pot apparatus as described herein and growing a plant in the pot; With the pot in the first position, providing nutrients to the plant; Rotating the pot to the second position and flushing out nutrients from the soil into the tray.

The invention further extends to a plant pot system comprising a pot and a support, wherein the pot comprises a sidewall connected to a base, with the base being provided with a recess, wherein the support is provided with a protrusion on which the pot is positioned to raise it. This allows a pot to be supported in a position where the base of the pot is raised and water can drain from within the soil out of drainage holes. The support and pot may be formed as separate parts or may be integrally formed. The use of a ‘leg’ and a ‘foot’ to raise the pot and support it can assist with flushing nutrients from within the soil. The water passes through drainage and/or air holes in the pot.

Advantageously, and provide a gap between the surface on which the support rests and the base of the pot, and wherein at least one air channel is provided to direct air flow to the recess of the pot. The support is provided with sloping sides to assist with guiding the flow of air towards the base of the pot.

Preferably, the base of the pot is provided with a holes about the recessed region to allow air to flow into the bottom of the pot.

In one construction, the air channel is provided as a recessed region in the protrusion of the base. In an alternatively construction, channel is provided as a recessed region in the base of the pot. A combination for the air channel being formed by both parts could be used but it is preferred for one or the other part to form the main part of the channel in order to assist with easier manufacturing.

Advantageously, the channel is at least partially tapered to assist with forcing the air into the bottom of the pot. By tapering the channel the air flow speed and pressure can be changed in order to improve the penetration of the air into the breather holes of the pot.

The invention further extends to a system, wherein the support rests upon a rimmed tray with the pot positioned on top of the support and wherein a hose-holding peg is placed in the pot and a hose-holding attachment is placed in the tray. By providing water to the soil and pumping, or sucking, the water out of the tray, soil in the pot can be flushed out quickly and efficiently. The peg and the attachment could be used separately rather than being used in combination, but for best results they are used together.

The invention also extends to a method of cultivating plants, wherein an arrangement as described above paragraph is defined is employed and wherein and the hose connected to the hose-holding peg provides water to soil in the pot and the hose-holding attachment removes water from the rimmed tray as it drains from the pot. The tray may be provided with an angled surface so that the water drains to the lowest point and the hose for removing the water is positioned at that point, thereby removing water from the tray where it collects.

By ‘nutrient’ is meant any substance provided to the plant during cultivation, for example salts, fertilizer, organic compounds etc. in liquid, mist, vapor or dry form.

The invention has been described by way of examples only and it will be appreciated that variation may be made to the above-mentioned embodiments without departing from the scope of invention.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

FIG. 1 shows an isometric view of a first embodiment of the invention;

FIG. 2a shows a side view of the embodiment in FIG. 1 in a first, lower position;

FIG. 2b shows a side view of the embodiment in FIG. 1 in a second, raised position;

FIG. 3 shows an exploded side view of the components of the embodiment in FIG. 1;

FIG. 4a shows a perspective view of the support means of the present invention;

FIG. 4b shows a top view of the embodiment in FIG. 1;

FIG. 5 shows an exploded bottom-up isometric view of the embodiment in FIG. 1 with the pot separated from the tray;

FIG. 6 shows a cross-section of the embodiment in FIG. 1 in the first, lowered position;

FIG. 7 shows a cross-section as in FIG. 6 with the pot lifted from the first, lowered position but not yet rotated to the second, higher position;

FIG. 8 shows a cross-section as in FIG. 6 with the pot lifted and rotated to the second position;

FIG. 9 shows a cross-section of a further embodiment of the present invention;

FIG. 10a shows a hose attachment for use with the present invention; and

FIG. 10b shows a second hose attachment for use with the present invention.

### DETAILED DESCRIPTION

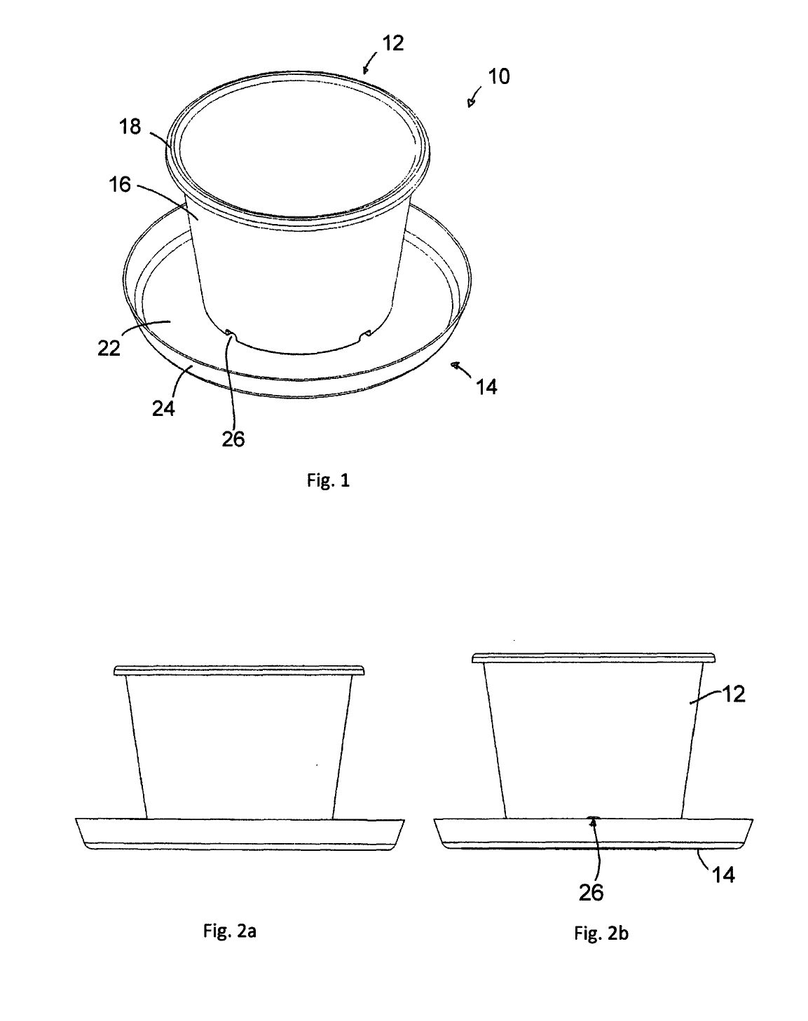

Referring to FIGS. 1 to 8; an embodiment of the plant pot apparatus 10 of the invention comprises a pot 12 and a tray 14, the pot 12 comprising a sidewall 16, a rim 18 and a base 20 and the tray comprising a base 22 and a rim 24. The pot comprises a number of air breather holes 26 opening to the side of the pot 12. The pot 12 is movable between a first lower position as shown in FIG. 2a in which the base 20 of the pot 12 rests on the base 22 of the tray 14 and a second higher position as shown in FIG. 2b in which the base 20 of the pot 12 is held above the base 22 of the tray 14.

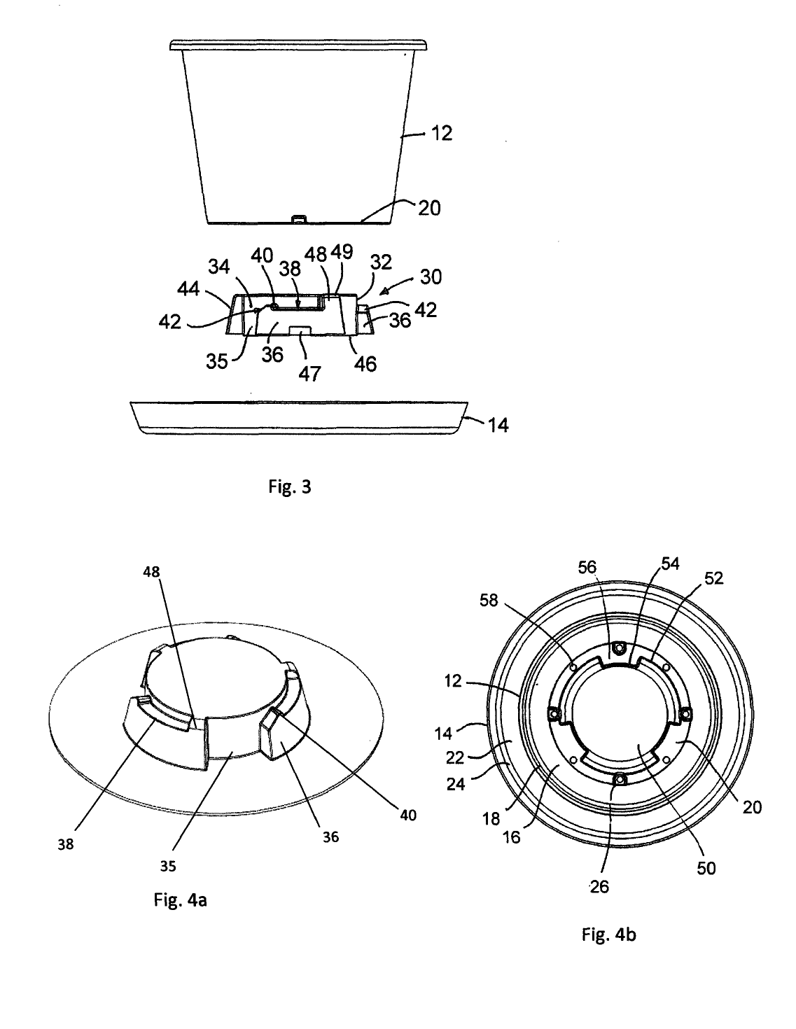

The plant pot apparatus 10 comprises a support means in the form of a tray insert 30 comprising an upstanding portion 32 comprising a sidewall 34 that is substantially cylindrical in form and comprises a number of projections 36 from its circumference. The sidewall 34 comprises a number of straight regions 35 between the projections. The sidewall 34 is shown as being substantially vertical in FIG. 3 but may have an upwards taper. The projections 36 comprise ledges 38 having substantially horizontal upper surfaces and raised portions of the ledge surface 40 at a first end of the ledge and a stop portion 48 at the second end. The tray insert 30 preferably has sloping sides as shown at 44 to provide a large, stable base and a tapered profile adapted to fit easily into the recess 50 provided in the base 20 of the pot. The projections 36 preferably comprise a sloping region 42 adjacent to the straight regions 35 of the upstanding portion 32. Preferably the base 46 is flat and is adapted to fit into location features provided on the base of the tray.

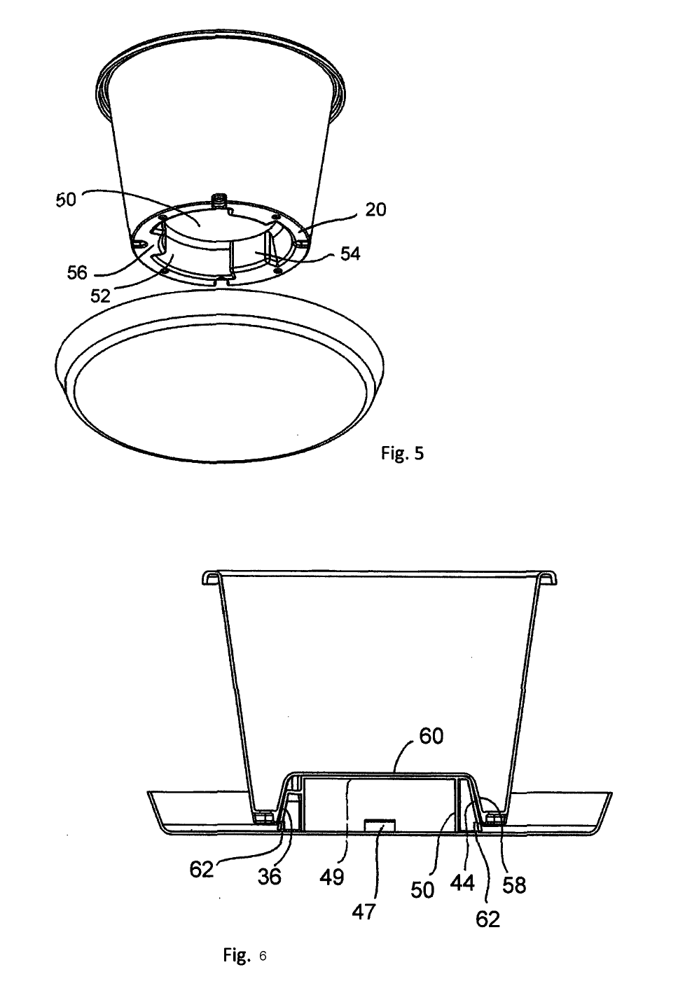

As shown in FIGS. 4 and 5 the base 20 of the pot comprises a recess 50 having a circumference 52 with indents 54. The number of indents 54 matches the number of projections and ledges on the tray insert. The indents 54 provide support features 56 of the base of the pot that lies inwards of the majority of the circumference of the recess.

Cross-sectional diagrams of the plant pot assembly as the pot is moved from the first to the second positions are shown in FIGS. 6 to 8. In FIG. 6 the pot is in the first, lower position, in this embodiment with the top 60 of the recess in the base resting on the upper surface 49 of the tray insert. In some embodiments in the first position the pot may rest instead with the rim of its base on the base of the tray. Retaining features 62 are provided to locate the tray insert in position in the tray. Features 62 may comprise a raised ring in some embodiments to position the tray insert centrally in the tray. They may comprise means to hinder rotation of the tray insert relative to the tray. In some embodiments the tray insert and retaining features are adapted to hold the tray insert laterally, rotationally and vertically. In some embodiments the features 62 may have a snap fit action to fix the tray insert in place to the tray.

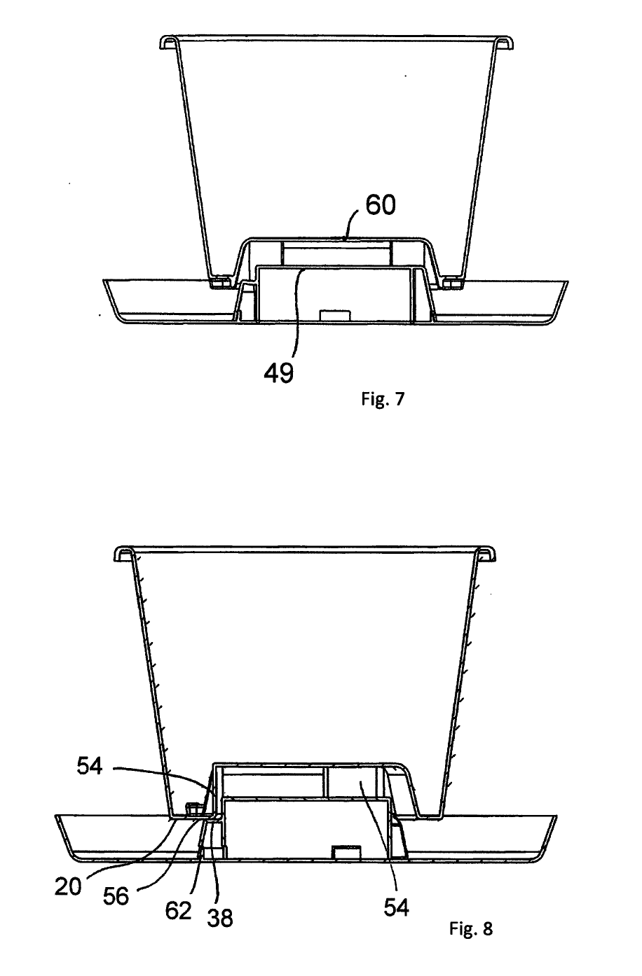

In FIG. 7 the pot has been lifted prior to rotating it to the second position. In FIG. 8 the pot is in the second position. Support features 56 of the recess rest in contact with the ledges 38 and the base of the 20 is held above the base of the tray to an extent in use that it is clear of liquid nutrients in the tray. The plant may be flushed when in this position to clear excess nutrients from the soil. Water inlets 47 are provided in the tray insert to allow the interior of the tray insert to hold liquid also, so maximizing the volume that may be held in the tray.

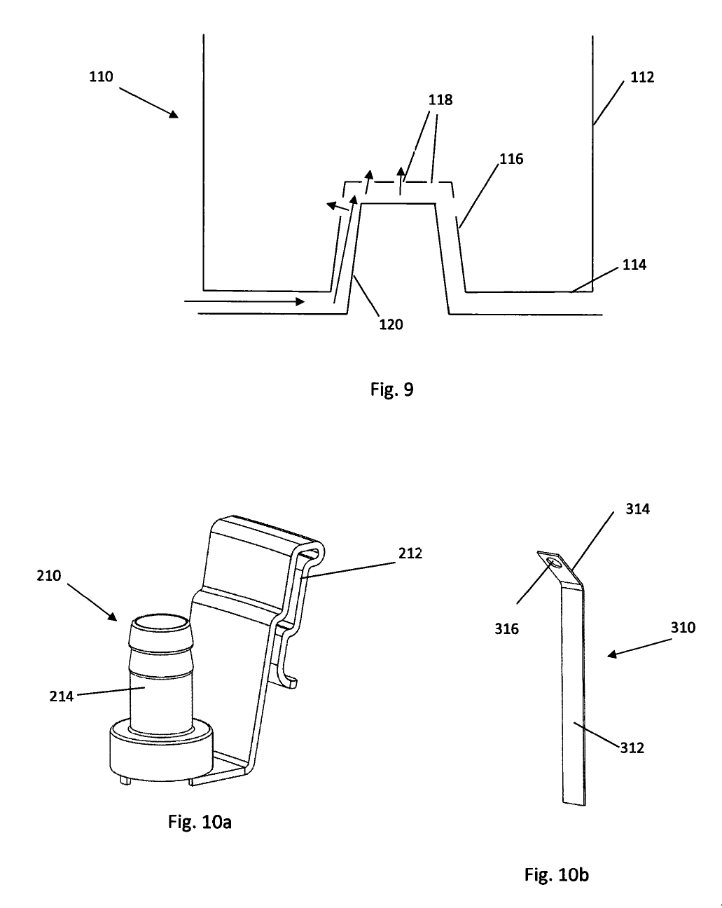

FIG. 9 shows a pot 110 having a side wall 112 integrally connected to a base 114. The base 114 of the pot 110 is provided with a recess 116, and the recess 116 comprises breather holes 118. The pot 110 rests upon a support 120, which is received within the recess 116 of the base 114 of the pot 110. When the pot 110 is supported on the base 114, a channel is formed between the base 114 of the pot 110 and the top surface of the support 120. As shown by the arrows, the channel allows air to flow towards the recess 116 of the pot 110 and, due to the angled shape of the support, the air is directed towards the holes 118 of the pot 110. The air bounces off the sloped walls of the support and is guided to the central recess 116 and the holes 118 of the pot. Therefore, the root core that would be positioned in the pot 110, when in use, is provided with airflow.

The arrangement shown in FIG. 9 is one particular embodiment of the pot and, clearly, the holes 118 can be of any size and shape and there may be any number of them. The air channel shown in FIG. 8 may be incorporated into the two-position plant pot system. Alternatively, it may be a stand-alone feature with the pot and the pot and support may be provided with a single vertical position, rather than being height-wise adjustable. The air breather holes 26 of the embodiment of FIGS. 1 to 8 may be adapted to incorporate them into a pot having the features shown in FIG. 8, or similar.

FIG. 10a shows a hose attachment 210 for use with the present invention when the system includes a tray. The attachment 210 comprises a clip portion 212 for engaging the rim of the tray and that has an inverted U-shaped profile. At the end of the clip portion 212, which is intended to be internal to the tray, when in use, is a hose attachment 214 for connecting a hose to the device 210. The hose can be used to drain water from the pot or to provide a constant supply of water to the tray. Additionally, or alternatively, the hose attachment 210 may be positioned within the pot so that the soil therein can be flushed through continuously.

FIG. 10b shows a peg 310 for use with a hydroponic pot according to the present invention. The peg 310 comprises an elongate lower member 312 and an upper member 314 angled so as to be in a different plane from that of the lower member 312. The upper member 314 comprises an aperture, or hole, 316 for accepting a hose. The peg 310 is pushed into soil within the pot and a hose is connected to the peg 310. The peg 310 is inserted into the pot adjacent an internal sidewall of the pot to avoid damaging the roots of the plant. The elongate and flat nature of the peg 310 allows it to slide along the soil and the root base without significant disruption to the roots.

When the hose attachment 210 and the peg 310 are used in combination, the resulting system allows a hose to provide water to the soil at the top, via peg 310, and a hose to remove water from underneath the pot, via the hose attachment 210. By removing the water as it drains, the likelihood of the roots sitting in water is reduced.

The assembly may comprise a series of different height adjustments by providing ‘steps’ or ledges on the support and/or on the pot. The different height steps allows for the pot to be placed at a series of different heights, thereby allowing the pot to be partially raised or fully raised, relative to the surface upon which the support rests.

Where a tray is used to support the support means, and more particularly where a lipped tray is used, the height to which the base of the pot is raised should, preferably, be about the height of the top of the tray or lip thereof. This allows the water to run over the edge of the tray and so keeps the roots away from the water.

The plant pot assembly may be formed from materials such as plastics materials, including molded polypropylene.

1. A plant pot system for flushing nutrients from soil contained therein, the system comprising:
a pot having an outer wall connected to a base, wherein a recess is provided within the base of the pot and the recess has a plurality of support indents extending into the recess with channels therebetween, the channels being substantially perpendicular to the base of the pot and extending towards the top of the recess; and
a support means comprising at least one ledge about its circumference and arranged, in use, to support the pot;
wherein at least a portion of the support means is received within the recess of the pot in a first position, and in a second position, wherein the pot is rotationally offset from the first position with respect to the support, less of the support means is accepted within the recess and the at least one support indent of the pot rests upon the at least one ledge of the support means.

2. The system according to claim 1, wherein the support means comprises a protrusion extending in an intended upward direction.

3. The system according to claim 2, wherein the support means comprises at least one substantially circular cross section upstanding portion shaped and sized to be received within the recess of the pot.

4. The system according to claim 1, wherein the pot is configured to be moved between the first and second positions by a user lifting the pot substantially vertically clear of the support means and rotating it before setting it down on the support means.

5. The system according to claim 1, wherein the support means is provided with a plurality of ledges about its circumference, forming straight regions of sidewall therebetween, the straight regions extending substantially perpendicularly from the base of the support means in the direction of the protrusion, and wherein in the first position the support indents of the pot are accepted within the straight regions of the support means and the ledges of the support means are accepted into the channels of the pot.

6. The system according to claim 1, wherein the at least one ledge is provided with a raised portion at one edge to prevent accidental movement of the support indent off the ledge when in the second position.

7. The system according to claim 1, wherein the pot is configured so that when the support means is in the second position, an air channel is created to allow air flow to the recess in the base of a pot and to the root core adjacent thereto, when in use.

8. The system according to claim 1, wherein the support means is arranged upon a tray.

9. The system according to claim 8, wherein the support means is separable from the tray.

10. The system according to claim 8, wherein the support means is permanently attached to or forms part of the tray.

11. The system according to claims 8, wherein the tray is provided with a rim.

12. A plant pot system comprising a pot and a support, wherein the pot comprises a sidewall and base with the base being provided with a recess, wherein the support is provided with a protrusion on which the pot is positioned to raise the pot from the surface in which the support is positioned.

13. The plant pot system according to claim 12, wherein a gap is provided between the surface on which the support rests and the base of the pot, and wherein at least one air channel is provided to direct air flow to the recess of the pot.

14. The system according to claim 13, wherein the base of the pot is provided with a holes about the recessed region to allow air to flow into the bottom of the pot.

15. The system according to claim 13, wherein the air channel is provided as a recessed region in the protrusion of the support.

16. The system according to claim 13, wherein the air channel is provided as a recessed region in the base of the pot.

17. The system according to claim 13, wherein the channel is at least partially tapered to assist with forcing the air into the bottom of the pot.

18. The system according to claim 12, wherein the support rests upon a rimmed tray and the pot is positioned on top of the support and wherein a hose-holding peg is placed in the pot and a hose-holding attachment is attached to the tray.

19. A method of cultivating plants, wherein:
the following arrangement is employed:
a plant pot system comprising a pot and a support, wherein the pot comprises a sidewall and base with the base being provided with a recess, wherein the support is provided with a protrusion on which the pot is positioned to raise the pot from the surface in which the support is positioned,
wherein the support rests upon a rimmed tray and the pot is positioned on top of the support and wherein a hose-holding peg is placed in the pot and a hose-holding attachment is attached to the tray; and
a hose connected to the hose-holding peg provides water to soil in the pot and the hose-holding attachment removes water from the rimmed tray as it drains from the pot.

20. A method of cultivating plants comprising the steps of:
providing a plant pot apparatus comprising:
a pot having an outer wall connected to a base, wherein a recess is provided within the base of the pot and the recess has a plurality of support indents extending into the recess with channels therebetween, the channels being substantially perpendicular to the base of the pot and extending towards the top of the recess, and
a support means comprising at least one ledge about its circumference and arranged, in use, to support the pot,
wherein at least a portion of the support means is received within the recess of the pot in a first position and in a second position, wherein the pot is rotationally offset from the first position with respect to the support means, less of the support means is accepted within the recess and the at least one support indent of the pot rests upon the at least one ledge of the support means; and
growing a plant in the pot with the pot in the first position, providing nutrients to the plant, rotating the pot to the second position and flushing out nutrients from the soil into the tray.
